(19) United States
(12) Patent Application Publication
(10) Pub. No.: US 2011/0032258 A1
(43) Pub. Date: Feb. 10, 2011

(54) SOURCE CODE GENERATOR FOR A GRAPHICS CARD

(75) Inventors: Pei Xing Dongmei, Saint-Maur-des-Fosses (FR); Henri Fousse, Courdimanche (FR)

Correspondence Address: DARBY & DARBY P.C., P.O. BOX 770, Church Street Station, New York, NY, 10008-0770, US

(73) Assignee: THALES, Neuilly Sur Seine (FR)

(21) Appl. No.: 12/663,397

(22) PCT Filed: Jun. 4, 2008
(86) PCT No.: PCT/EP08/56937

§ 371 Date: Aug. 1, 2010

(30) Foreign Application Priority Data
Jun. 5, 2007 (FR) 0704011

(51) Int. Cl. G06T 15/80

(52) U.S. Cl. 345/426

(57) ABSTRACT

The present invention relates to a source code generator 20 for a graphics card used by a software application.

Unitary shaders having common characteristics are defined according to a common structure defined by a basic shader. The basic shader comprises the common characteristics of the unitary shaders and common interfaces for the software application.

The source code generator 20 is a generator of shaders, generating one or more shaders 24 for the graphics card by combining the unitary shaders 21 according to one or more descriptions of combinations 22 of unitary shaders 21.

The source code generator 20 can be used to produce a source code to manage the combination of visual effects, notably for an application generating images in real time for a simulation or a video game.

### CROSS REFERENCE TO RELATED APPLICATIONS

The present application is the U.S. National Phase of International Patent Application Serial No. PCT/EP2008/056937, filed Jun. 4, 2008, which claims priority to French Patent Application Serial No. 0704011, filed Jun. 5, 2007, both of which are hereby incorporated by reference in their entireties.

### BACKGROUND OF THE INVENTION

The present invention relates to a source code generator for a graphics card. The source code generator can be used to produce a source code to manage combinations of visual effects, notably for an application generating images in real time for a simulation or a video game.

### BRIEF DESCRIPTION OF THE PRIOR ART

Environment simulations, notably dedicated to the training of aircraft pilots, require a high degree of realism in the visual representation of the environments. In practice, the rendering quality of surfaces and atmospheric conditions greatly affect the appreciation by the pilot of visual markers used in the landing and take-off phases.

Visualization software applications can notably be used to reproduce virtual environments used in simulations for example. The visualization software applications are run by a processor of a computer. Then, a graphics card makes it possible to display images, generated in real time by the software application, on a screen linked to the computer.

A graphics card is an extension card for a computer that is used to store and interpret images generated by a visualization software application running on the processor of the computer for example. The continual updating of the images on the screen, for the visualization of a sequence of images for example, is handled by the graphics card. The rendering quality is therefore notably linked to the performance of the graphics card used in order to allow for a visual representation of an environment.

The development of graphics cards based on programmable graphics processors, also called GPU, an acronym standing for graphic processing unit, has significantly improved the real time generation of images. This improvement relates to both the quality of the images and the performance in terms of image display refresh speed. Furthermore, the GPU programming has been made more effective and the programs produced more comprehensible with the introduction of programming languages for specific parts of the GPU.

The configuration of a graphics card, notably in order to be able to have visual effects on the images displayed, is performed via a program commonly designated “shader”. A shader is a program comprising a source code consisting of instructions written in a comprehensible language. A shader therefore makes it possible to configure one or more parts of the graphics card. The shader thus makes it possible to intervene at various steps in a chain of graphics information processing operations performed by the graphics card. The code of a shader is compiled by a compiler dedicated to each type of graphics card in order to obtain a program that can then be run on the GPU.

Because of the trend in image formats toward increasingly fine definitions, the manufacturers of graphics cards are having to develop increasingly powerful GPUs. The GPU processors are capable of performing multiple operations in parallel and in real time. These performance characteristics are notably used by game software in order to represent more and more realistic environments, but also increasingly by computation software performing complex computation operations.

However, the programming of the shaders suffers from a lack of flexibility. In practice, a shader program is a series of generally monobloc code instructions describing, for example, all the possible display effects for a given visualization application. With visualization software applications combining more and more visual effects, it is becoming increasingly difficult to integrate the shaders with the visualization applications. In particular, the interfaces between the shaders and these applications must be set once and for all. Any interface modification potentially means overwriting almost all the code of the shader. An interface modification also has a not-inconsiderable impact on the programs of the applications that use shaders. For big applications, in other words applications with many functional modules using a plurality of shaders, the writing of the shaders is then difficult and inflexible. The capabilities for change of the shaders during the development of the to application, notably the addition of new effects, requires almost all the code of the shader concerned to be overwritten. In practice, a shader code cannot be structured by combining individual subroutines for example.

In a real time visualization application, used notably for environment simulation, the issue of the combination of visual effects arises. Consider for example the desire to display a terrain comprising a water surface, this terrain being flown over by a beacon illuminating it. The display effects to be described to display this scene are, for example, a terrain effect, a water effect and a light source effect. To produce a display rendering of the light source effect on the water surface or on the terrain, it is necessary to describe in the shader the possible combinations of the three effects: for example, terrain without light source, terrain with light source, water without light source, water with light source. Generally, the number of renderings to be described in the shader is equal to the number of combinations of effects that a visualization application produces. The addition of a new effect therefore entails writing all the renderings corresponding to the new combinations of the existing effects with the new effect. These constraints therefore induce high costs in the development of visualization applications and the associated shaders, as well as high costs for the maintenance and upgrading of such applications and such shaders.

A first solution according to the prior art is described by Niklas Folkegard and Daniel Wesslen in the work entitled Dynamic Code Generation for Realtime shaders. The aim of this first solution is to reduce the redundancies in the coding of the shaders, notably in the description of the effects. To this end, Folkegard and Wesslen propose dividing a shader program into small code portions. Then, a combiner assembles these parts in order to construct a conventional shader program from parameters given by a user. Each portion comprises:
a description of the input data or of preconditions of use of the code portion,
a code comprising computations and operations, and
output data or post-conditions of use of the code portion.

The combiner takes account of the parameters given by the user, and assembles the compatible parts according to the parameters and the input and output data of each portion. The combiner then supplies a new shader code comprising all the possible combinations. The time taken by the combiner to assemble all the portions is all the longer when it has to take into account numerous portions. In applications that use a wide combination of effects, it is impossible to describe each portion with its input and output data, the breakdown level being too fine.

A second solution makes it possible notably to avoid loops and dynamic branches in the shader. This solution is implemented in a gaming engine called Far Cry, a registered trademark of Ubisoft Entertainment, and described by Carsten Wenzel in Far Cry and DirectX, GameDevelopers Conference, DirectX being a registered trademark of Microsoft Corporation. This gaming engine performs a shader precompilation with different masks for the light sources. Then, the gaming engine uses a cache system to accelerate the installation of the shader at the moment when a rendering is used by a visualization application. This amounts to using a general shader comprising all the effects combined together, by removing, at the moment when the shader program is run, the undesirable effects in the image currently being displayed. This technique can be used only when the number of effects is limited, as in a game. It is impossible to implement this solution when there is a wide combination of effects.

A third solution is proposed by Dominic Filion in Recombinant Shaders in Game Programming Gems 5. This third solution also uses a generiC shader in which are defined insertion points that make it possible to generate shader variants by the addition and subtraction of shader code portions. These insertion points define processing operations to be performed according to a context corresponding for example to an insertion point. This solution can be produced by the insertion of preprocessor instructions into the shader code. The preprocessor instructions enable a compiler to determine the code to be used in order to generate an executable shader program. The main drawback of this solution is the limited number of possible insertion points. This limitation makes it impossible to manage numerous combinations of effects.

Another solution implemented by M. McCool et al. is described notably in Shader Algebra and Metaprogramming GPUs with Sh. This solution relies on a meta-language called Sh, that can be used in order to develop shaders. A meta-language is a formal language used to describe one or more programming languages such as, for example, the languages specifically for programming a shader. This meta-language proposes algebraic connection and combination operators notably for unitary shaders considered as objects. A unitary shader can be a shader describing an effect. The code of the shaders is then compiled in order to give a standard shader code. This approach facilitates the integration of the shaders with visualization applications. However, developing a shader in a language other than a programming language specific to the shaders, and developing a compiler specific to the meta-language limits the possibilities of optimizing the graphics card shader processing operations. This can have the effect of degrading the real time display performance for a complex image.

### SUMMARY OF THE INVENTION

One aim of the invention is notably to overcome the abovementioned drawbacks. To this end, the subject of the invention is a source code generator for a graphics card, used by a software application.

Unitary shaders having notably common characteristics are defined according to a common structure defined by a basic shader. The basic shader comprises, for example, the common characteristics of the unitary shaders. The basic shader can comprise common interfaces for the software application 32.

The source code generator is a generator of shaders generating one or more shaders for the graphics card by combining the unitary shaders according to one or more descriptions of combinations of unitary shaders.

The generator can associate a unitary key with each unitary shader and with each combination of unitary shaders. The unitary keys generated are, for example, supplied to the software application.

The software application is, for example, a visualization application. A unitary shader corresponds for example to a visual effect. A combination of unitary shaders corresponds for example to a rendering combining several visual effects.

The software application is, for example, a computation application. The unitary shader is, for example, a unitary computation operation. A combination of unitary shaders is, for example, a complex computation operation combining several unitary computation operations.

The source code of the generated shaders is, for example, coded with a GLSL language, or Graphic Library Shading Language, created by OpenGL ARB.

The generator can be coded with an object language.

Another subject of the invention is a method of generating source code for a graphics card. The method notably comprises the following steps:
definition of unitary shaders. The unitary shaders notably have common characteristics. The unitary shaders can be defined according to a common structure. The common structure is, for example, defined by a basic shader comprising the common characteristics of the unitary shaders. The basic shader can also comprise common interfaces for the software application;
generation, by a source code generator, of shaders for the graphics card by combining the unitary shaders according to one or more descriptions of combinations of unitary shaders.

A unitary key is, for example, associated with each unitary shader. A unitary key is, for example, associated with each combination of unitary shaders resulting from the composition of the unitary keys of the combined unitary shaders.

The software application is, for example, a visualization application. A unitary shader corresponds, for example, to a visual effect. A combination of unitary shaders corresponds, for example, to a rendering combining several visual effects.

The software application is, for example, a computation application. A unitary shader is, for example, a unitary computation operation. A combination of unitary shaders is, for example, a complex computation operation combining several unitary computation operations.

The invention notably has the main advantages of allowing for a flexible and inexpensive programming of shaders for graphics cards, while optimizing the access times of the software applications to the executable shader programs.

### BRIEF DESCRIPTION OF THE DRAWINGS

Other characteristics and advantages of the invention will become apparent from the following description, given by way of illustrative and nonlimiting example, and in light of the appended drawings which represent:

FIG. 1: a exemplary schematic diagram of a design of a shader according to the invention;

FIG. 2: an example of generation of an executable program by a GPU according to the invention;

FIG. 3: an example of use of a shader generator according to the invention;

FIG. 4: various possible steps in implementing the shader according to the invention.

### DETAILED DESCRIPTION

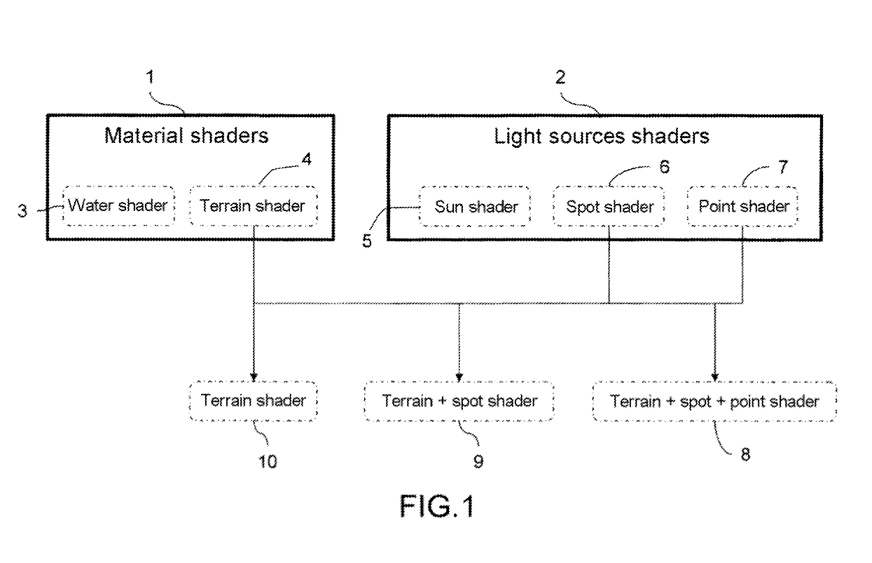

FIG. 1 represents an exemplary schematic diagram of the design of shaders. The shaders are, for example, defined for a visualization application.

To display an image, one or more visual effects can be used in order to obtain a rendering combining these effects. For example, to represent a liquid surface lit by the sun, a water effect and a sun effect can be combined. In this example, the sun has a light source function whereas the water has a material function on which the light source is reflected for example. It is thus possible to classify the desired effects for a visualization application according to several categories. The effects belonging to one and the same category have common characteristics such as a lighting function for the light sources. For example, it is possible to use a materials category, a light source category, an atmosphere category, a geometry category. Since the number of categories depends on the visual effects to be produced, it is therefore unlimited.

To display a point of an image obtained notably from a real time visualization application, a shader program will be used that corresponds, for example, to a rendering. A rendering is a combination of one or more visual effects. By defining categories of effects a rendering on a point of a three-dimensional space of a simulated environment can be expressed in the form of an equation. The equation gives, for example, the color C of the point according to one or more effects belonging to one or more categories. C can be defined as the result of a function that takes into account:

none, one or more geometries;

none, one or more materials;

none, one or more light sources;

none, one or more atmospheres.

C can be described as follows:

C=function (Geometry, Materials, Light_source, Atmosphere)

Each effect of each category can be defined by a unitary shader. The shaders corresponding to the effects of one and the same category can have common characteristics. These common characteristics may be, for example:
for a light source category: a lighting intensity, a lighting direction, a lighting function;
for a materials category: a color, a texture, a reflection power, a light reflection function.
   This makes it possible to define a common shader structure for each category of unitary shaders that is defined. This common shader structure is, for example, a common structure of material shaders 1 or a common structure of light source shaders 2. The unitary shaders belonging to the structure of material shaders 1 such as the water shader 3 and the terrain shader 4 therefore have a common structure. These common shader structures notably exploit possibilities specific to the programming languages of the shaders: the structure and the function surcharge. The function surcharge makes it possible notably to define a function generically, for example at the level of the structure of material shaders 1. Then, this function can be described accurately in each unitary shader such as the water shader 3 and the terrain shader 4.

In the same way as a common structure of material shaders 1 is defined, it is possible to define a common structure of light source shaders 2 for a sun shader 5, a spot shader 6 and a point shader 7, the latter corresponding to an effect relating to a point light source.

A unitary shader, corresponding, for example, to an effect, can therefore be defined as a pseudo-class of an object language with interfaces and a structure. Thus, the unitary shaders that have one and the same common shader structure notably implement the same interfaces. The interfaces are defined according to a formal system suitable for the definition of common interfaces between the different unitary shaders. In practice, the interfaces have the same structures, they take into account the same parameters for example, but the instructions carried out in each interface function can be specific to each unitary shader.

A name space can also be defined in each unitary shader. This name space makes it possible to define functions or function parameters, variables, having the same name for all the shaders belonging to one and the same category for example, but representing different functions or variables depending on the name space in which they are defined. This facilitates the integration of the shaders by the applications. For example, a visualization application can then use the same names for the interfaces, whatever the effects of a category used. This adds a great degree of flexibility when it comes to the programming of the interfaces of the shaders with the applications. The visualization applications, for example, do not necessarily need to know in detail the functions, parameters and variables of each unitary shader. The visualization applications then know only the interfaces of the basic shaders. This makes the unitary shaders and the visualization applications relatively independent inasmuch as a change to a unitary shader has little impact on the coding of an application.

The unitary shaders and the shader structures can be coded in different languages. One effective way of coding the different shaders is to use a language dedicated to the graphics cards thus making it possible to control and optimize execution parameters of the shader programs on a GPU. These languages can be, for example: GLSL, standing for Graphic Library Shading Language, CG, standing for C like Graphic, HLSL standing for High Level Shading Language, developed by Microsoft.

From unitary shaders, a generator according to the invention can, for example, automatically compose a new shader 8: the terrain+spot+point shader 8 as being the composition of the following unitary shaders: terrain shader 4, spot shader 6 and point shader 7. In the same way, the shader generator according to the invention can also compose a terrain+spot shader 9 and a terrain shader 10.

The definition of unitary shaders and the management of these unitary shaders in a modular manner makes it possible to simplify the combination of the shaders. Notably, a definition of common interfaces between the different unitary shaders makes it possible to combine them simply without having to adapt the interfaces to each change of combination of shaders.

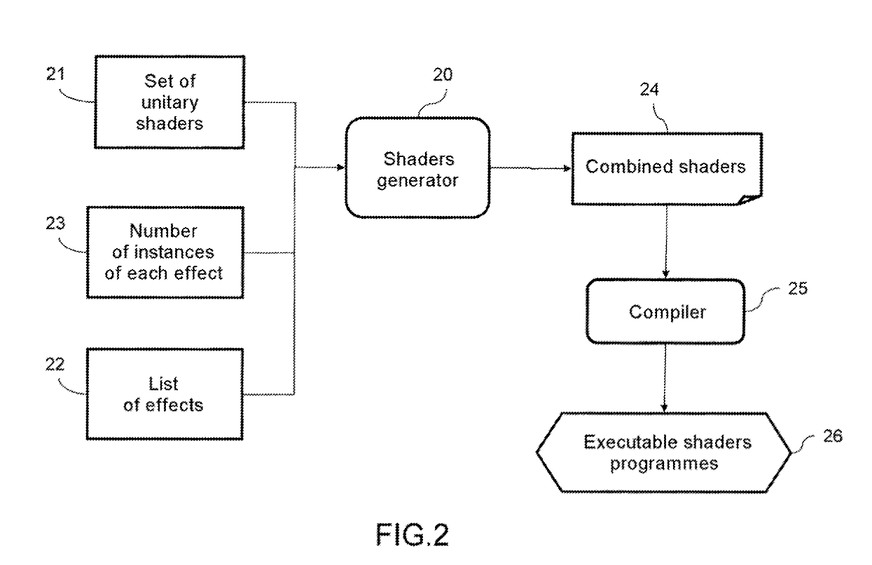

FIG. 2 diagrammatically represents an example of operation of a shader generator 20 according to the invention.

The shader generator 20 can take into account the different unitary shaders 21. Each unitary shader 21 corresponds, for example, to an effect. Then, from an input list of different effects 22 of a scene of an environment to be simulated for example, the shader generator computes the useful combinations of unitary shaders 21 for the scene. The list of the different effects 22 is a description of combinations of effects and therefore of unitary shaders 21. Since an environment to be simulated can comprise a number of scenes, the shader generator 20 can take into account several lists of scene effects for example. Then, the shader generator 20 generates combined shaders 24 for the scene or scenes. Advantageously, the generator can take into account all the combinations of effects needed for an application. All the combined shaders needed for an application can therefore be generated. This makes it possible to modify, dynamically and in real time, the effects while the application is running.

The combined shaders 24 are generated in a programming language specific to the graphics card, such as GLSL, CG or HLSL for example. The code of the combined shaders 24 is then compiled by a compiler 25 specific to the type of graphics card on which the executable shader programs 26 obtained after compilation are run.

The use of a language dedicated to the graphics cards, also called graphics card native language, advantageously makes it possible to reuse shaders already defined for other applications and to use them without translation to another language.

Advantageously, the formal system adopted to define the common interfaces of the unitary shaders can be adapted to the structure of the native language of the graphics card. This allows for an upstream optimization of the GPU management code, said optimization being carried out by the compiler compiling the combinations of shaders. In practice, the compilers are adapted to optimize the GPU management code. This advantageously makes it possible to avoid optimization phases that are complex and costly in time. Furthermore, an a posteriori optimization of the code necessitates an optimization on each modification of a combination.

Another advantage associated with the use of native code of the graphics cards is to provide the everyday users of graphics cards with tools for generating shaders in a language that they already know. The use of the generator does not therefore necessitate any particular knowledge.

The shader generator 20 is an executable program whose code can be written in any computer language. For example, the shader generator 20 can be coded with an object language such as C++. The executable program of the shader generator 20 is generated by a compiler dedicated to the language in which the shader generator 20 is coded.

Parameters can be taken into account by the shader generator 20 such as a number of instances of each effect 23. This makes it possible to optimize the code of the combined shaders 24 in order notably to optimize the execution of the corresponding shader executable programs 26. Other parameters can be taken into account to optimize for example the processes of the shader generator 20.

This way of generating the combined shaders 24 makes it possible to write the code of the unitary shaders 21 just once. The code of the unitary shaders 21 is then used by the shader generator 20 to generate the code of the combined shaders 24.

The use of a formal system suitable for defining common interfaces also makes it possible to limit the constraints of taking into account the combinations of unitary shaders by the compiler adapted to the graphics card used and by the shader generator 20.

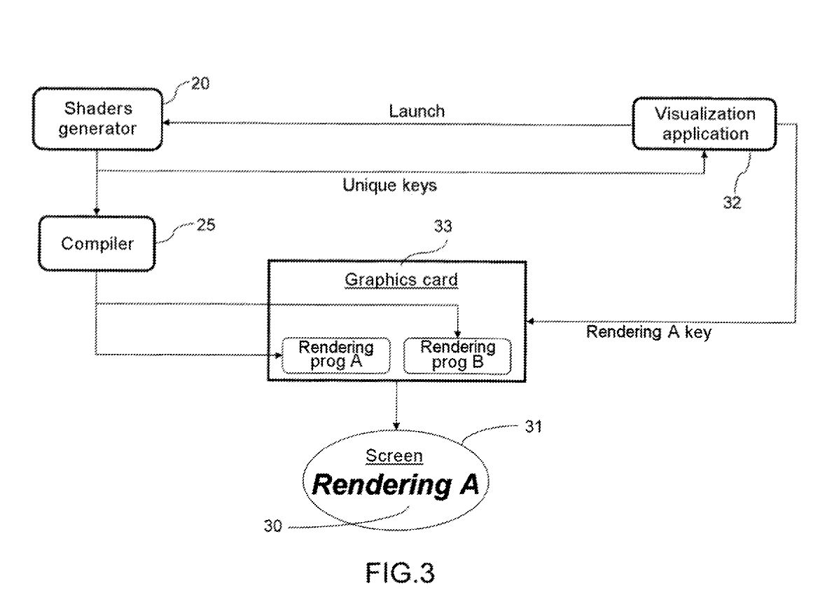

FIG. 3 represents an example of integration of a shader generator 20 in a rendering engine. A rendering engine is, for example, the set of methods and devices implemented to display a rendering A 30 of an image on a screen 31. A visualization application 32 can use shaders to compose different effects on an image. The visualization application 32 can take into account a list of different effects available in the shaders 24 generated by the shader generator 20. The visualization application 32 can therefore use in its code different effects coded in the combined shaders 24.

Initially, while the visualization application 32 is being launched, the shader generator 20 generates the combined shaders 24. Then, the combined shaders 24 are compiled by a shader compiler 26. A shader executable program 26, associated with a rendering, is then stored in the graphics card 33 to be executed by the graphics card 33 at the request of the visualization application 32. For example, a shader executable program 26 can give one or more rendering executable programs, such as the rendering prog A, or the rendering prog B, prog being an abbreviation for program.

In order to accelerate the display of a rendering, the shader generator 20 can generate a unique key, coded on a bit field, for each effect. The different unique keys generated are supplied to the visualization application 32. The shader generator 20 and the visualization application 32 can use the unique effect keys to compose a unique rendering key corresponding to a combination of desired effects. A rendering key can be a bit field, corresponding for example to the sum of the keys of the desired effects. A unique rendering key is then associated by the compiler 25 with each rendering program. For example, in FIG. 3, the visualization application 32 wanting to display a rendering A 30 composes a rendering key A. Then, the visualization application 32 supplies the rendering key A to the graphics card 32 which can quickly find the rendering prog A corresponding to the rendering key A. For example, the rendering key A can be a number of a cell of a table, each cell of the table corresponding to a rendering program. Then, the graphics card 32 displays the image with the rendering A 30 on the screen 31.

The generation of a unique key can be generalized to other types of applications: a unique key can be associated with each unitary shader and with each composition of unitary shaders.

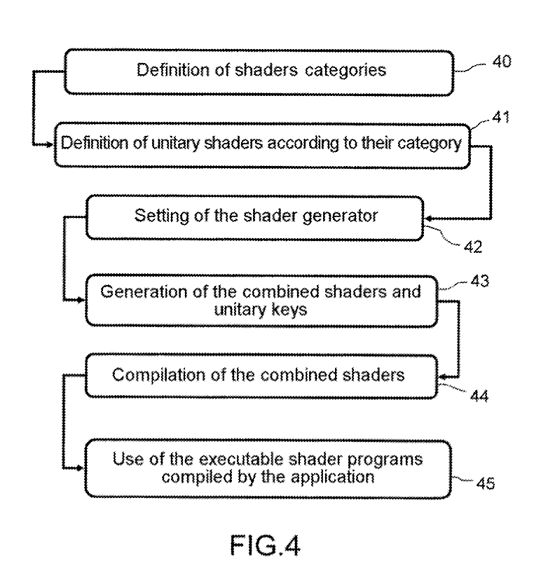

FIG. 4 represents different possible steps of a method of generating and implementing shaders according to the invention in the context of a visualization application for example.

A first step 40 is a step for definition of different categories, for example, of effects to be implemented for a given visualization application notably. The categories are defined generically and can be reused for another visualization application for example. For example, it is possible to define a material category, a light source category, an atmosphere category, a geometry category. The definition of a category makes it possible to define a common shader structure that can be called basic shader. A basic shader corresponding to a category notably comprises the definition of functions, interfaces, parameters and variables that are common to all the shaders of the defined category.

A second step 41 is a step for definition of the unitary shaders. The unitary shaders represent, for example, an effect belonging to a category. The definition of a unitary shader is the definition of the body of the functions and of the interfaces defined in the basic shader of the category to which the unitary shader belongs. A unitary shader can also comprise functions, interfaces, parameters or variables that are specific to it.

A third step 42 is a step for configuring the shader generator 20. This step is used notably to specify, for example, a list of the desired effects 22 combining several unitary effects and the number of instances of each effect 23. The configuring of the shader generator 20 also makes it possible to describe all the unitary shaders to be taken into account by the generator in order to generate the effects 23.

A fourth step 43 is a step for generation of the combined shaders 24 by the shader generator 20. The combined shaders 24 generated in this way can be used notably to produce the effects described in the list of effects 22 for a scene.

A fifth step 44 is a step for compilation of the combined shaders 24 by the shader compiler 25, specific to the graphics card 33. The compilation of the combined shaders 24 produces a set of shader executable programs 26, in other words a set of rendering programs such as rendering prog A and rendering prog B.

A sixth step 45 is a step for use of the rendering programs by the visualization application 32 in order to display an image with a rendering 30 on a screen 31.

A method of generating shaders as described can be used to carry out computations with a graphics card. A graphics card can be used to perform parallel computations such as the vector computation for example. The application using the shaders is then a computation application.

The unitary shaders defined in this case can, for example, correspond to unitary operations that can be grouped together, for example, into families of operations according to their characteristics in order to define categories of operation, the computation application then combining the unitary operations in order to perform complex operations in parallel on the graphics card. This makes it possible to exploit the computation power of a graphics card inexpensively.

It is then highly advantageous to be able to use a, flexible and economic method of programming shaders such as the generation of shaders according to the invention.

The method according to the invention advantageously makes it possible to define shaders in a modular manner and to manage combinations of shaders. The modular definition of the shaders advantageously makes it possible to simplify the integration of the shaders with a computation or visualization application.

The invention therefore offers great flexibility in programming shaders intended for graphics cards. This flexibility is reflected in a timesaving in developing shaders also leading to a reduction in the development costs of an application using a graphics card. Notably, a shader programmer does not need to manage the combinations of the various unitary shaders to create a complex effect; in practice, the combination of the unitary shaders is produced automatically by the generator.

Advantageously, the generator makes it possible to automatically create combined shaders, notably thanks to the common interfaces between the unitary shaders.

The definition of unitary keys for the shaders allows for an increase in the speed of execution of the choice of a shader executable program by the application.

This speed and this flexibility therefore advantageously make it possible to manage shaders for a real time application, using a graphics engine, and having, for example, a large number of visual effects to be produced or a large number of complex computations to be carried out.

1.-10. (canceled)

11. A source code generator for a graphics card used by a software application, wherein:
unitary shaders having common characteristics are defined according to a type of shader defined by a basic shader, said basic shader comprising the common characteristics of the unitary shaders and common interfaces for the software application;
said source code generator is a generator of shaders, automatically generating all the combined shaders necessary to the software application for the graphics card, said combined shaders resulting from the combination of the unitary shaders according to one or more descriptions of combinations of unitary shaders, said combined shaders being used by the software application;
the unitary shaders, the basic shaders and the generated shaders being coded in a language dedicated to the graphics card.

12. The generator as claimed in claim 11, associating a unitary key with each unitary shader and with each combination of unitary shaders, the unitary keys generated being supplied to the software application.

13. The generator as claimed in claim 11, wherein the software application is a visualization application, a unitary shader corresponding to a visual effect, a combination of unitary shaders corresponding to a rendering combining several visual effects.

14. The generator as claimed in claim 13, taking into account a number of instances of an effect in the visualization application.

15. The generator as claimed in claim 11, wherein the software application is a computation application, a unitary shader being a unitary computation operation, a combination of unitary shaders being a complex computation operation combining several unitary computation operations.

16. The generator as claimed in claim 11, wherein the source code of the generated shaders is coded with a GLSL language, or Graphic Library Shading Language.

17. The generator as claimed in claim 11, being coded with an object language.

18. A method of generating source code for a graphics card, comprising at least the following steps:
defining of unitary shaders, the unitary shaders, having common characteristics, being defined according to a type of shader defined by a basic shader, said basic shader comprising the common characteristics of the unitary shaders and common interfaces for the software application;
automatically generating, by a source code generator, of all the combined shaders necessary to the software application) for the graphics card, said combined shaders resulting from the combination of the unitary shaders according to one or more descriptions of combinations of unitary shaders, said combined shaders being used by the software application;
the unitary shaders, the basic shaders and the generated shaders being coded in a language dedicated to the graphics card.

19. The method as claimed in claim 18, wherein:
a unitary key is associated with each unitary shader;
a unitary key is associated with each combination of unitary shaders, resulting from the composition of the unitary keys of the combined unitary shaders.

20. The method as claimed in claim 18, wherein the software application is a visualization application, a unitary shader corresponding to a visual effect, a combination of unitary shaders corresponding to a rendering combining several visual effects.

21. The method as claimed in claim 20, comprising a step for configuring the source code generator defining a number of instances of an effect in the visualization application.

22. The method as claimed in claim 18, wherein the software application is a computation application, a unitary shader being a unitary computation operation, a combination of unitary shaders being a complex computation operation combining several unitary computation operations.
